(19) United States
(12) Patent Application Publication
(10) Pub. No.: US 2003/0021969 A1
(43) Pub. Date: Jan. 30, 2003

(54) Reflective heat-shrinking film

(76) Inventors: Robert J. Aloisi, Kaukauna, WI (US); Richard E. Fredricks, Appleton, WI (US); Michael A. Schmelzer, Appleton, WI (US)

Correspondence Address: Finnegan, Henderson, Farabow,, Garrett & Dunner, L.L.P., 1300 I Street, N.W., Washington, DC, 20005-3315, US

(21) Appl. No.: 10/183,470

(22) Filed: Jun. 28, 2002

Related U.S. Application Data
(60) Provisional application No. 60/301,981, filed on Jun. 29, 2001.

(51) Int. Cl. B32B 7/02

(52) U.S. Cl. 428/212

(57) ABSTRACT

A heat shrink film includes a thin film substrate, a radiant energy absorbent layer, and a radiant energy reflective layer, wherein the radiant energy reflective layer contains an amount of metallic color sufficient to reflect radiant energy. The heat shrink film may also include metallic particles sufficient ti reflect radiant energy.

### DESCRIPTION OF THE INVENTION

1. Field of the Invention

This invention pertains to a heat-shrinking film. In particular, this invention pertains to heat-shrinking film for lidding an open-topped container.

2. Background of the Invention

Presently, in the fast food drink industry, it is typical to serve a drink in a paper, plastic, or other disposable cup topped with a preformed plastic lid. The plastic lid fits relatively tightly over the brim formed at the top of, for example, a paper drink cup, and may include apertures to permit straws or openings to be formed in the lid to allow one to directly drink the contents of the cup without removing the lid.

Unfortunately, there are many problems associated with the use of these plastic lids. For example, the lids are bulky and create problems in storage and in disposal. Still further, the seal formed by the lids is dependent upon the lid being placed on the cup properly, and can leak if not properly placed.

In order to overcome these problems, various devices and methods have been proposed in which a cover is placed on an open-topped container and then heated to shrink it into sealing engagement with the top of such a container. These prior art devices and methods, however, fail to provide a sufficiently cost efficient, easy, and inexpensive alternative to preformed rigid plastic lids. As a consequence, rigid plastic lids remain in widespread use.

Some of the main failings of these prior devices are that they are bulky, noisy, unresponsive, and expensive. Heating systems comprising blowing air over a hot element and then onto a film require large amounts of unnecessary heat, even when in standby mode, which makes temperature control very difficult. Further, continuous elevated temperatures are expensive to maintain and may be undesirable to the immediate environment.

An improvement to these prior art systems is found in a device described in U.S. Pat. No. 5,249,410, incorporated herein by reference, which uses heat shrinkable film lids having annular energy absorbent regions formed thereon, preferably by application of an energy absorbent ink such as by printing. In this device for shrinking thin film over a container to form a lid, multiple radiant energy sources are utilized. The primary radiant energy source is located closely adjacent to the lip of the cup and moves peripherally around the lid while a secondary radiant energy source is stationed over the cup. When the primary energy source is activated, energy falling upon the energy absorbent region in the film causes the film to shrink, preferentially in the area around the lip of the cup, while energy from the secondary energy source may serve to tauten up the central portion of the lid. Alternatively, multiple primary radiant energy sources can be located around the periphery of the mouth of the cup. The apparatus disclosed in the '410 patent does not detail an efficient method of concentrating and redirecting energy toward the region of the film which is to be shrunk. In other arrangements, multiple energy sources at fixed locations, are provided.

In each of the above, it is desirable that the heat shrink film be optimized to obtain maximum results. In particular, it is desirable that the heat shrink film efficiently absorb radiant energy from the radiant energy source so that the film heats sufficiently to fully shrink over the top of the open-topped container. Optimization of the energy absorption quality of the printed film includes increasing the amount of energy absorbed by the energy absorbing layer, as well as increasing the amount of energy that contacts the energy absorbing layer.

In a known heat shrink film disclosed in U.S. Pat. No. 5,993,942, the film includes an energy absorbing layer and a reflective layer. The energy absorbing layer, which is black in color, contains carbon black pigment to enhance energy absorption. The reflective layer is white, containing titanium dioxide pigment to provide reflective properties, as well as to provide the color. To achieve desired reflection properties in the reflection layer, however, large amounts of titanium dioxide pigment are required.

The present invention addresses these problems by providing a heat shrink film having multiple layers, including at least one energy absorbent layer and at least one energy reflecting layer. The energy absorbent layer preferably contains an energy absorbing material, such as carbon black. The energy reflecting layer can be metallic, and may contain aluminum flake, gold flake, brass flake, bronze flake, and the like.

Further advantages of the invention will be set forth in part in the description which follows and in part will be apparent from the description or may be learned by practice of the invention. The advantages of the invention may be realized and attained by means of the instrumentalities and combinations particularly pointed out in the appended claims.

### SUMMARY OF THE INVENTION

As embodied and broadly described herein, the invention includes a heat shrink film comprising a thin film substrate, a radiant energy absorbent layer, and a radiant energy reflective layer, wherein the radiant energy reflective layer contains an amount of metallic particles sufficient to reflect radiant energy. The invention further includes a flexible film for forming seals for open mouth containers, comprising a heat shrinkable thin-film substrate, at least a portion of said substrate bearing both a radiant energy absorptive layer and a radiant energy reflective layer, said reflective layer containing an amount of metallic particulates sufficient to reflect radiant energy. The invention still further includes a flexible film for forming seals for open mouth containers, comprising a heat shrinkable thin-film substrate, at least a portion of said substrate bearing both a radiant energy absorptive layer containing carbon black and a radiant energy reflective layer including metallic particles in an amount sufficient to reflect radiant energy.

The accompanying drawings, which are incorporated herein and constitute a part of this specification, illustrate an embodiment of the invention, and, together with the description, serve to explain the principles of the invention.

### BRIEF DESCRIPTION OF THE DRAWINGS

FIG. 1 illustrates a reflective hood for use with the present invention.

FIG. 2 illustrates an embodiment of the film of the present invention.

FIG. 3 illustrates another embodiment of film of the present invention.

### DESCRIPTION

Reference will now be made in detail to the present preferred embodiments of the invention, examples of which are illustrated in the accompanying drawings. While the following description is directed to use of heat shrink film on open-topped containers, such as cups, those of ordinary skill in the art will appreciate that the invention is equally applicable to use on other open-topped containers, such as food cartons.

In accordance with the invention, as broadly described, the heat-shrink film includes a thin energy absorbent film having a radiant energy absorbing layer and a radiant energy reflective layer, wherein the reflective layer is metallic. In one embodiment the metallic reflection layer contains an amount of metallic particles sufficient to reflect radiant energy. The metallic particles may be aluminum. Those of ordinary skill in the art will understand that a variety of metallic particles can be used to achieve the same results, including gold, silver, brass, or bronze particles.

The present invention can be used with a reflective hood system described below. A reflective hood system includes an energy source, a reflective hood, an optional reflective shield, and an optional protective optical element. In general, the radiant energy source preferably emits radiant energy. A portion of the emitted radiant energy contacts the surface of the reflective hood until finally directed toward a thin energy-absorbing film that will shrink when impinged by the radiant energy. A portion of the remaining radiant energy is redirected by the reflective shield and is directed back to the reflective hood and to the thin film.

In the present invention, film is provided covering the top of, and extending downwardly past the brim of, an open-topped container, such as a drinking cup. The radiant energy from the radiant energy source is directed to the area just below the periphery of the top of the cup, i.e., just below the brim. Thus, the radiant energy causes the film to shrink in the area around the brim, thereby forming a lid. The thin film of the present invention is described below.

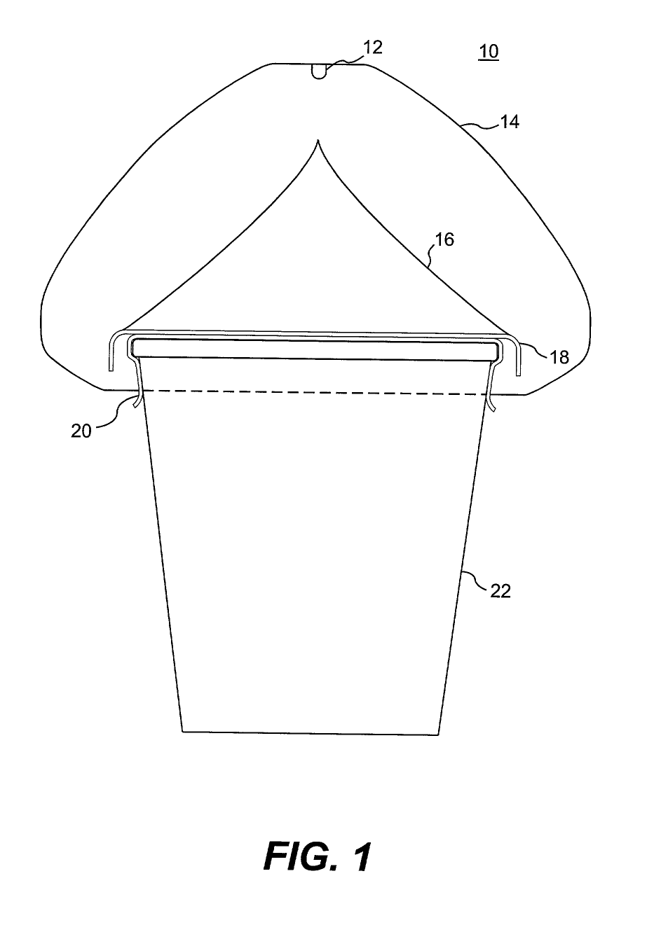

In an embodiment of the invention, as shown in FIG. 1, the reflective hood assembly 10 includes a radiant energy source 12, a reflective hood 14, a reflective shield 16, and a protective optical element 18. The protective optical element 18 may be any art recognized or after developed material. The protective optical element 18 may be any art recognized or after developed material. The protective optical element 18 may be glass, plastic, or other material that will allow sufficient radiant energy to pass therethrough. The radiant energy source 12 produces radiant energy for shrinking a film 20 by emitting radiant energy having wavelengths in the visible and near infrared range. Those of ordinary skill in the art will understand that the wavelength of the energy emitted by the radiant energy source is not particularly critical so long as the ink chosen is sufficiently absorbent over a range of the wavelengths emitted that film shrinkage is reasonably rapid. Of course, it is preferable to ensure that the surfaces serving as reflectors are actually reflective for radiation in the chosen wavelengths if significant radiation outside the visible range is emitted.

In particular, a convenient radiant energy source 12 is a conventional halogen lamp emitting light energy having wavelengths at least between approximately 600-1400 nm. It has been found that tungsten halogen lamps are a preferred radiant energy source 12. However, those of ordinary skill in the art will understand that a number of different radiant energy sources are available which produce sufficient visible and near infrared radiation, such as xenon arc lamps. The energy source is preferred to have a wattage of between 150-1000 watts for compatibility with standard electrical wiring/circuiting.

The reflective hood 14 reflects the radiant energy emitted from the radiant energy source 12 and directs it to the area where film shrinkage is desired, i.e., the target area. In one embodiment, the inner surface of the reflective hood 14 has a smooth, mirror-like surface to aid in reflecting the radiant energy. In this embodiment, the inner surface can have, for example, a metallized silver-coated or gold-coated mirrored surface to reduce reflection losses. Those of ordinary skill in the art will understand that there are a variety of surfaces and coatings that can be used to reflect radiant energy. In addition, those of ordinary skill in the art will understand that similar results can be achieved using different numbers of surfaces and shapes.

The reflective shield 16 is a cover that substantially prevents radiant energy from contacting certain areas of the film 20 located over the mouth of the cup, keeping those areas from shrinking. In addition, the reflective shield reflects the radiant energy, directing it back to the reflective hood 14, where it is eventually directed to the target area. The reflective shield 16 may be shaped to form an opposing side to the curve-shaped reflective hood 14 so as to optimize reflection of the radiant energy. For instance, in the embodiment shown in FIG. 1, it is desired that the radiant energy generally not contact the area of the film 20 covering the open portion of the container 22. Accordingly, the reflective shield is positioned over the top of the film 20 to prevent the radiant energy from contacting the film positioned over the open portion of the beverage container 22. In some applications, energy may be intentionally directed to certain areas over the mouth of the container to cause selective shrinking, as an aid in, for example, forming apertures for straws. The reflective shield 16 may be constructed to prevent visible and near-infrared radiant energy from penetrating through the shield 16.

The reflective shield 16 may have a metallized surface that reflects radiant energy as discussed above. Further, the reflective shield 16 may have a metallic mirrored surface to more efficiently reflect the radiant energy. Thus, when the radiant energy source 12 emits radiant energy, some of the radiant energy is directed to the area covered by the reflective shield 16. This radiant energy reflects off the reflective shield 16, contacts the reflective hood 14, and is directed through a reflection, or a series of reflections, to the target area.

In one embodiment the radiant energy source 12, reflective hood 14, and reflective shield 16 are protected by a protective optical element 18, although the apparatus will function without the optical element 18 in place. The protective optical element 18 prevents liquids from contacting the radiant energy source 12, the reflective hood 14, and the reflective shield 16. The protective optical element 18 may be any art recognized or after developed material. The protective optical element 18 may be glass, plastic, or other material that will allow sufficient radiant energy to pass therethrough.

In operation, the beverage container 22 is filled with a liquid beverage, such as water, soda, carbonated or non-carbonated, or coffee. During the lidding operation, described below, liquid can splash onto parts of the reflective hood assembly 10, such as the radiant energy source 12, reflective hood 14, or reflective shield 16, causing damage or reducing efficiency. The protective optical element 18 is preferably integral with the reflective hood assembly 10.

The lidding operation of the described apparatus will now be explained. After the beverage container 22 is filled with the desired beverage, the operator places the beverage container 22 in contact with the film 20 and in proximity of the reflective hood assembly 10. As the beverage container 22 is placed into position, the radiant energy source 12 is activated, emitting radiant energy. The radiant energy emits diffusely in all directions contacting either the reflective hood 14 or the reflective shield 16. Through either one or a series of reflections, the radiant energy is directed to the desired shrinkage area of the film 20 located around the brim of the beverage container 22. As the radiant energy contacts the film 20, radiant energy is absorbed and the film 20 shrinks, forming a seal around the lid of the beverage container 22. The beverage container 22 is then removed from the reflective hood assembly 10.

A heat-shrink film of the present invention will now be described. In one embodiment the film is a bi-axially oriented thin shrink film having a preferred thickness of between 40 to 120 gauge (1.02 mm to 3.05 mm), with a more preferred film having a thickness of between 60 to 100 gauge (1.52 mm to 2.54 mm). One film that has been used is a 75 gauge (1.91 mm) DuPont Clysar ABL polyolefin shrink film. Appropriate shrink film would be readily apparent to the skilled artisan. Any art recognized film would be appropriate, such as 75 gauge (1.91 mm) Intertape Exfilm polyolefin biaxially oriented shrink film. When used to cover food products, the film should be food contact-approved by the appropriate regulatory authorities. Those of ordinary skill in the art will understand that a variety of film compositions are available for use with the present invention. For example, the film can be made of polyethylene, polypropylene, polyolefin, or any film that will shrink when contacted by radiant energy.

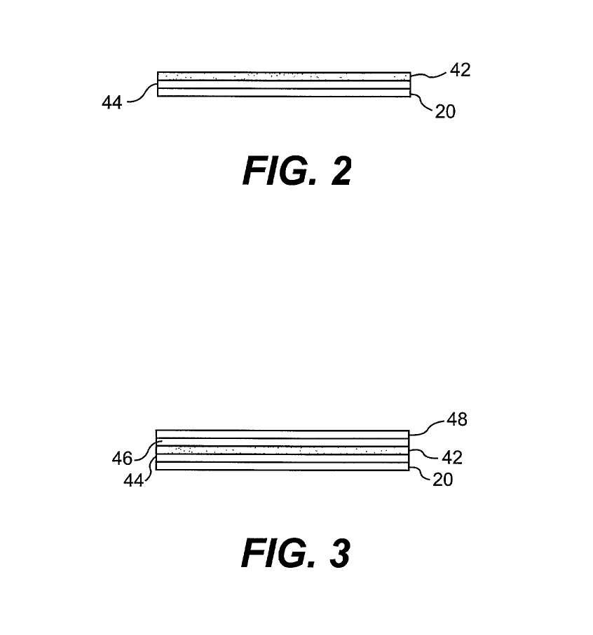

As shown in FIG. 2, to ensure that the film 20 shrinks at the desired rate when contacted by radiant energy, it is generally desired for the film to be coated with at least one radiant energy absorbent layer 42 and at least one radiant energy reflective layer 44. In one embodiment, the absorbent layer 42 and the reflective layer 44 are ink layers. The absorbent layer 42 may include an energy absorbing substance, which enhances the shrink rate of the film. In particular, if a faster shrinkage rate is desired, the amount of energy absorbent pigment is increased. One such substance that works well in this environment is carbon black pigment. Other substances that would achieve satisfactory results include graphite and iron oxide. The carbon black pigment may be included as a functional component in ink that is applied to the surface of the film 20.

In one embodiment, the energy absorbent layer 42 is either black or a dark color, such as blue. Carbon black, or some other energy absorbing pigment, can be added to the ink to provide the desired shrinkage rate of the film. It is further preferred that the energy absorbent layer 42 be applied at a rate of at least approximately 0.30 dry pounds per 3000 sq. ft. of energy absorbent film. When it is desired to include an energy absorbing active pigment such as carbon black in the ink, it is preferred that the active pigment be applied at a rate of at least approximately 0.03 dry pounds per 3000 sq. ft. of energy absorbent film. Those of ordinary skill in the art will understand that the amount of ink and active pigment used will vary with the desired shrink rate of the film.

One blue ink composition that has been tested and found adequate is Coates Blue TN15629, available from Coates Inks, Inc. of Greer, S.C. It is preferred that the Coates Blue TN15629 be applied at a rate of approximately 0.58 dry pounds per 3000 sq. ft. of film, including approximately 0.03 dry pounds per 3000 sq. ft. of film of active pigment, e.g., carbon black.

One black ink composition that has been tested and found adequate is Coates Black TN15787, available from Coates Inks, Inc. of Greer, S.C. When used, it is preferred that the Coates Black TN15787 be applied at a rate of approximately 0.97 dry pounds per 3000 sq. ft. of film, including approximately 0.44 dry pounds per 3000 sq. ft. of film of active pigment, e.g., carbon black.

Those of ordinary skill in the art will understand that the aforementioned ink compositions are only two of many dark inks that will perform sufficiently as an energy absorptive layer, and that adjustments can be made to these inks that will not adversely effect their performance. Moreover, those of ordinary skill in the art will understand that a colored film can also be achieved by blending a pigment color into the polymer.

The reflective layer 44 is interposed between the energy absorbent layer 42 and the film substrate 20. The reflective layer 44 acts as a reflector and reflects some of the radiant energy that passes through the energy absorbing layer 42 back to the energy absorbing layer 42, thereby increasing the amount of energy absorbed by the energy absorbing layer 42. In one embodiment the reflective layer 44 includes a reflective pigment. The reflective pigment may be metallic. A metallic reflective layer can be achieved by adding metallic particles to the ink that forms the layer. In one embodiment, the reflective layer 44 is gold or silver in color. A silver color can be achieved using silver flakes or aluminum flakes. A gold color can be achieved using either gold flakes or tinted aluminum flakes. Other ways of providing various metallic colors to the reflective layer will be obvious to those of ordinary skill in the art.

Those of ordinary skill in the art will understand that there are other ways of achieving the reflective properties of the reflective layer described below. For example, a reflective metallized coating could be applied to the film in a separate metallizing unit. An absorbent layer could then be applied to the metallized film. Another way of achieving similar results is to include metallic particles in the film resin itself prior to extrusion. An absorbent layer could then be applied to the metallized film. Moreover, metal laminate could be applied to a film. An absorbent layer could then be applied to the laminated film.

In one embodiment according to the present invention, the reflective layer 44 is silver in color. Aluminum particles can be added to the reflective layer to both provide the desired color and to give the layer reflective properties. The silver reflective layer may be applied at a rate of at least approximately 0.20 to 1.50 dry pounds per 3000 sq. ft. of film. In addition, active reflective pigment, e.g., aluminum flake, may be applied at a rate of at least 0.10 dry pounds per 3000 sq. ft. of film. Those of ordinary skill in the art will understand that the amount of reflective ink and active reflective pigment used will vary with the desired shrink rate of the film. Moreover, the amount of ink and active pigment used will vary with the amount of absorbing ink and absorbing pigment used.

One silver ink composition that has been tested and found adequate is Coates Silver TN15771, available from Coates Inks, Inc. of Greer, S.C. It is preferred that the Coates Silver TN15771 be applied at a rate of approximately 0.92 dry pounds per 3000 sq. ft. of film, including approximately 0.15 dry pounds per 3000 sq. ft. of film of active pigment, e.g., aluminum flake.

Another silver ink composition that has been tested and found adequate is Coates Silver TN13443, available from Coates Inks, Inc. of Greer, S.C. It is preferred that the Coates Silver TN13443 be applied at a rate of approximately 0.43 dry pounds per 3000 sq. ft. of film, including approximately 0.22 dry pounds per 3000 sq. ft. of film of active pigment, e.g., aluminum flake.

Each of the above-described silver reflective layers can be used in combination with each of the above-described absorbent layers, e.g., the black layer or the blue layer. Moreover, each of the above described silver reflective layers can be used in combination with any known absorbent layer. In addition, the amounts of active pigments in each layer can be adjusted as necessary. In particular, the absorbent active pigment, e.g., can be increased and the reflective active pigment, e.g., aluminum flake, can be decreased, while still maintaining a high overall absorption rate. In the alternative, if less absorbent active pigment is desired, the amount of reflective active pigment can be increased to offset the decrease in absorbent pigment. Moreover, while a silver colored ink is being used for the above example, those of ordinary skill in the art will understand that other metallic-colored films, such as gold, brass, or bronze, will achieve similar results.

The effectiveness of the metallic-colored inks is exemplified by a silver ink using metallic particles and is depicted by the test results, described below. In particular, when using a reflective layer containing metallic particles, sufficient absorption in the absorptive layer can be achieved by using both less active pigment in the reflective layer and less active pigment in the absorptive layer, as compared to films using a white reflective layer. In addition, superior absorption can be achieved by increasing the active pigments in either the reflective layer or the absorptive layer to the levels found in the prior art.

The reflective qualities of the silver reflective layers as compared to the white reflective layer are shown in the following Table 1, below. In particular, a weighted average percent reflection was determined for each of the reflective layers, which evidences the amount of radiant energy that is reflected by the reflective layers. The weighted average percent reflection is the percentage amount of energy that is reflected from the reflective layer over the light spectrum. To determine the amount of radiant energy that is reflected, the reflective layer is placed under a light source. The amount of light that passes through the reflective layer is then measured. Because the absorption qualities of the reflective layers are very small, it is assumed that the majority of the energy that does not pass through the reflective layer was reflected. The experimental apparatus utilized to record the percent absorption spectral data utilizes two different light sources to obtain spectral data in the 450 nm to 1000 nm region and the 1000 nm to 1600 nm region. In particular, the experimental apparatus used was a Sciencetech Model 9030 monochromator. The monochromator uses a 600 line per millimeter concave holographic diffraction grating. The 0.50-mm entrance and exit slits for the monochromator allowed approximately 8-nm resolution for the optical spectra produced. The spectrum of a 650-watt halogen bulb is shown below in Graph 1. To obtain the spectral range form 450 nm to 1600 nm, the lamp was operated at 105.5 V AC with a filament current of 5.0 A. The graph depicts the normalized relative intensity for the wavelengths across the 650-watt spectrum.

[image]

The testing apparatus uses narrow band filters that measure wavelengths over a series of gratings, e.g., 450-454 nm, to determine the amount of light that passes through the subject for that particular band of wavelengths. The apparatus automatically steps through the entire wavelength spectrum and determines the relevant amount of radiant energy that passes through. The weighted average was determined by multiplying the percent of energy that passed through by the normalized halogen lamp intensity at each wavelength, summing the result, subtracting that result from 1, and then multiplying the results by 100. Using the weighted average percent reflection, a reflection factor was then determined for each of the reflective layers. The reflection factor was calculated by dividing the weighted average percent reflection by the dry weight of the active reflective pigment per 3000 sq. ft. of the film. The results are as follows:

TABLE 1
Weighted Average Percent
Reflection of Reflective Layers Alone

| | Weighted | Amount of Active | |
|---|---|---|---|
| | Average Percent | Pigment, dry lbs per | Reflection |
| Test Ink Systems | Reflection | 3000 sq. ft. | Factor |
| Silver TN13443 | 63.6 | 0.22 | 289 |
| Silver TN15771 | 34.0 | 0.15 | 227 |
| White TN12316 | 59.7 | 1.08 | 51 |

As shown from the results of the test, the weighted average percent reflection of the Silver TN 13443 test sample was greater than the White TN12316 test sample, while the White TN12316 sample was greater than the Silver TN15771. Note also the reflection factor of the reflective layers. As shown above, the percent reflection for the amount of active pigment is substantially higher for the silver reflective layers—approximately 4-5 times higher. Thus, if equivalent amounts of active pigment were used in the silver reflective layers and the white reflective layer, the weighted average percent reflection in the silver reflective layers should be substantially higher than that of the white reflective layer. Moreover, similar results can be achieved when using other metallic reflective layers, such as gold, brass, or bronze.

The superior results achieved using a silver reflective layer are based, at least in part, on the ability of the silver reflective layer to maintain a more constant reflectivity over the entire relevant light spectrum. In particular, as shown below in Graph 2, the efficiency of a white reflective layer decreases as the wavelength of the energy increases. That is, the reflective efficiency of the white reflective layer decreases for radiant energy in the infrared wavelengths. The silver reflective layer, on the other hand, reflects energy at a consist rate throughout the entire relevant spectrum. The resulting effect is that a higher percentage of radiant energy can be reflected when using a silver reflective layer when compared to a white layer with similar amounts of active pigment.

[image]

As shown on the graph, the percent reflection of the white reflective layer steadily decreases as the wavelength of the radiant energy increases. Thus, for the white reflective layer, as the radiant energy wavelengths reach 1000 nm and longer, the reflectivity efficiency drops significantly. For the silver reflective layers, on the other hand, the percent reflectivity is relatively constant. As a result, the silver reflective layers have the ability to reflect relatively more radiant energy along the entire relevant wavelength spectrum.

To prove the superior effectiveness of films having a metallic reflective layer as compared to films having white reflective layers, four different films were tested. Two of the films tested had a silver reflective layer (the silver reflective layers being the Coates layers described above), one had a white reflective layer (the reflective qualities being provided by titanium dioxide), and one had a white reflective layer (titanium dioxide) interposed between a black absorbent layer and a red decorative layer, i.e., the reference film. The testing was similar to the testing described above. In particular, a weighted average percent absorption and reflection was determined for each of the tested films, which evidences the amount of radiant energy that is ultimately absorbed by the film. The weighted average percent absorption and reflection is the percentage amount of energy that is absorbed and reflected from the film over the relevant light spectrum. To determine the amount of radiant energy that passes through the film, the film is placed under a light source. The experimental apparatus utilized to record the percent absorption spectral data utilizes two different light sources to obtain spectral data in the 450 nm to 1000 nm region and the 1000 nm to 1600 nm region. In particular, the experimental apparatus used was a Sciencetech Model 9030 monochromator.

The testing apparatus uses narrow band filters that measure wavelengths over a series of gratings, e.g., 450-454 nm, to determine the amount of light that passes through the subject for that particular band of wavelengths. The apparatus automatically steps through the entire wavelength spectrum and determines the relevant amount of radiant energy that passes through. The weighted average was determined by multiplying the percent of energy that passed through by the normalized halogen lamp intensity at each wavelength, summing the result, subtracting that result from 1, and then multiplying the results by 100. The results are shown in Table 2.

TABLE 2
Weighted Average Percent
Absorption and Reflection of Ink System

| | | Amount of | Amount of |
|---|---|---|---|
| | | Reflecting | Absorbing |
| | Weighted | Ink, dry | Ink, dry |
| | Average | lbs per | lbs per |
| | Percent | 3000 sq. ft. | 3000 sq. ft. |
| Test Ink | Absorption & | total (active | total (active |
| Systems | Reflection | pigment) | pigment) |
| Silver TN13443/ | 83.4 | 0.43 (0.22) | 0.58 (0.03) |
| Blue TN15629 | | | |
| Silver TN15771/ | 93.1 | 0.92 (0.15) | 0.97 (0.44) |
| Black TN15787 | | | |
| White TN12316/ | 91.8 | 1.65 (1.08) | 1.12 (0.51) |
| Black TN15768 | | | |
| Reference Film | 88.5 | unknown | unknown |

As shown in the table, the average weighted percent absorption and reflection for each of the test samples is relatively high. However, when comparing the amount of ink applied in the reflective and absorptive layers, as well as the amount of active pigment applied in the reflective and absorptive layers, it is clear that the films having a metallic reflective layer, in this case silver, have superior reflective and absorptive qualities. In particular, it is clear that if equivalent amounts of ink and, in particular, active pigment were used in the films having a silver reflective layer as the film having a white reflective layer, the reflective and absorptive properties of the film having a silver reflective layer would be significantly better. Comparing the silver/black film with the white/black film shows that when a silver reflective layer is used the amount of active pigments for reflection and absorption can each be less while achieving superior results.

The results also show how variations in the active pigments can affect reflective and absorptive properties. In particular, the silver TN15771 ink has a lower amount of active pigment relative to the silver TN13443 or white inks, resulting in relatively lower percent reflection (see Table 1). However, the amount of active absorbing pigment in the black ink layer TN15787 is much higher than for the blue ink layer TN15629, which significantly improves absorption. The improvement is enough, in fact, that the silver/black film has a much higher weighted average percent absorption and reflection than the silver/blue film.

As depicted in Graph 3 below, the percent absorption remained relatively high at all wavelengths for all of the ink systems. However, the silver ink systems maintain a more constant percent absorption relative to white ink systems as the wavelength increases, as shown in Graph 3, below.

[image]

This is a result, at least in part, of the constant reflectivity of the silver reflective layer over the entire radiant energy spectrum of a typical halogen bulb (see Graph 1 above).

Another area where superior results can be achieved using a metallic reflective layer is the ability to use lighter, more decorative, colors on the top surface of the film. In particular, it is sometimes desired to apply a decorative layer above the absorbent layer. The decorative layer may contain colors that are lighter than the maroon and dark blue generally used. The decorative layer may also contain advertising slogans and indicia useful for identifying the contents of the lidded container. In prior art systems, this is achieved by the following structure: film/white reflective layer/black or maroon absorptive layer/white reflective layer/decorative layer. While the decorative results may be acceptable, absorptive efficiency in the absorptive layer is reduced. In particular, because the upper and lower white reflective layers are primarily effective in the visible and near infrared light spectrums (see Graph 1, above), the upper white layer reflects away a majority of the radiant energy that would be reflected back to the absorbent layer by the lower reflective layer. The result is that the impact and efficiency of the lower reflective layer is diminished and, accordingly, the amount of radiant energy available to the absorptive layer for absorption is likewise diminished.

When a metallic reflective layer is used, as shown in FIG. 3, such that the resulting film structure is film 20/metallic reflective layer 44/absorbent layer 42/white reflective layer 46/decorative layer 48, the amount of radiant energy available for absorption is increased as compared to the prior art. In particular, as shown in Graph 2 above depicting use of a silver layer, the effectiveness of the silver reflective layer 44 does not decrease for radiant energy in the infrared wavelength. Thus, when the radiant energy reaches the white reflective layer 46, while a portion of the radiant energy in the visible and near infrared wavelength is reflected, a substantial amount of infrared radiant energy passes through the white reflective layer 46. Because of the reflective qualities of the silver reflective layer 44 in the infrared wavelength range, most of the infrared energy is reflected back to the absorptive layer 42 and is available for absorption. The resulting effect is that the amount of energy available for absorption when using a silver reflective layer 44 is significantly higher than when using a lower white reflective layer.

Those of ordinary skill in the art will understand that a variety of ink colors can be used to obtain satisfactory results with the present invention and that a variety of number of ink layers can also be used. In addition, those of ordinary skill in the art will understand that it is not necessary to coat the entire film with ink. In particular, in those areas where shrinkage is not desired, the ink coating need not be applied and may, in fact, be undesirable. Moreover, those of ordinary skill in the art will appreciate that ink patterns can be used on any ink layer.

What is claimed is:

1. A heat shrink film comprising:
a thin film substrate;
a radiant energy absorbent layer; and
a radiant energy reflective layer, wherein the radiant energy reflective layer contains an amount of metallic particles sufficient to reflect radiant energy.

2. The heat shrink film according to claim 1 wherein the metallic particles are aluminum.

3. The heat shrink film according to claim 1 wherein the metallic particles are gold in color.

4. The heat shrink film according to claim 1 wherein the metallic particles are silver in color.

5. A flexible film for forming seals for open mouth containers, comprising:
a heat shrinkable thin-film substrate, at least a portion of said substrate bearing both a radiant energy absorptive layer and a radiant energy reflective layer, said reflective layer containing an amount of metallic particles sufficient to reflect radiant energy.

6. The heat shrink film according to claim 5 wherein the metallic particles are aluminum.

7. The flexible film according to claim 5 wherein the metallic particles are gold in color.

8. The flexible film according to claim 5 wherein the metallic particles are silver in color.

9. The flexible film according to claim 5 wherein the rediant energy absorptive layer contains carbon black.

10. A heat shrink film having a radiant energy reflective layer, the reflective layer having a reflection factor of at least about 220.

11. The heat shrink film according to claim 10 wherein the heat shrink film further includes a thin film substrate and a radiant energy absorbent layer.

12. The heat shrink film according to claim 10 wherein the radiant energy reflective layer contains an amount of metallic particles sufficient to reflect radiant energy.

13. The heat shrink film according to claim 12 wherein the metallic particles are aluminum.

14. The heat shrink film according to claim 12 wherein the metallic particles are gold in color.

15. The heat shrink film according to claim 12 wherein the metallic particles are silver in color.

16. The heat shrink film according to claim 10 including a heat shrinkable thin-film substrate, at least a portion of said substrate bearing both a radiant energy absorptive layer and the radiant energy reflective layer, the reflective layer containing an amount of metallic particles sufficient to reflect radiant energy.

17. The heat shrink film according to claim 16 wherein the metallic particles are aluminum.

18. The heat shrink film according to claim 16 wherein the metallic particles are gold in color.

19. The heat shrink film according to claim 16 wherein the metallic particles are silver in color.

20. The heat shrink film according to claim 16 wherein the radiant energy absorptive layer contains carbon black.

21. A heat shrink film comprising a thin film substrate wherein the substrate contains metallic particles sufficient to reflect radiant energy.

22. The heat shrink film according to claim 21 wherein the metallic particles are gold in color.

23. The heat shrink film according to claim 21 wherein the metallic particles are silver in color.

24. A heat shrink film comprising:
a thin film;
a metallic reflective layer;
an absorbent layer;
a white reflective layer; and
a decorative layer.

25. The heat shrink film according to claim 24 wherein the metallic reflective layer is silver in color.

26. The heat shrink film according to claim 24 wherein the metallic reflective layer is gold in color.

27. The heat shrink film according to claim 24 wherein the metallic reflective layer is aluminum.
